(19) United States
(12) Patent Application Publication
(10) Pub. No.: US 2013/0050822 A1
(43) Pub. Date: Feb. 28, 2013

(54) DISPLAY ELEMENT WITH POLARIZING FILM FOR A DISPLAY UNIT IN A VEHICLE

(71) Applicants: Manfred Suss, Remchingen (DE); Isabel Hoffmann, Walzbachtal (DE); Gerhard Kammerer, Konigsbach (DE); Heinrich Behrends, Bad Herrenalb (DE); Martin Mayer, Sinsheim (DE); Nicolas Mehl, Frankreich (FR); Peter Langer, Karlsruhe (DE)

(72) Inventors: Manfred Suss, Remchingen (DE); Isabel Hoffmann, Walzbachtal (DE); Gerhard Kammerer, Konigsbach (DE); Heinrich Behrends, Bad Herrenalb (DE); Martin Mayer, Sinsheim (DE); Nicolas Mehl, Frankreich (FR); Peter Langer, Karlsruhe (DE)

(73) Assignee: Johnson Controls Automotive Electronics GmbH, Remchingen (DE)

(21) Appl. No.: 13/577,415

(22) PCT Filed: Dec. 28, 2010
(86) PCT No.: PCT/EP2010/070807

§ 371 Date: Nov. 16, 2012

(30) Foreign Application Priority Data
Feb. 10, 2010 (DE) 10 2010 007 405.5
Nov. 1, 2010 (DE) 10 2010 043 200.8

(51) Int. Cl. G02B 5/30

(52) U.S. Cl. 359/483.01

(57) ABSTRACT

The invention relates to a display element for a display unit of a vehicle, said display element being formed from a substrate and a polarizing film. The display element may be backlit by means of a light source. The substrate may be imprinted with graphic symbols. The polarizing film may be a circular polarizing film.

### BACKGROUND

The invention relates to a display element for a display unit of a vehicle.

DE 198 04 150 B4 discloses a method for applying color filters and/or covering matrices composed of photoemulsion layers, and a laminate for application with photoemulsion layers. In the method, the color filters and/or covering matrices composed of at least one photoemulsion layer are applied to a rigid substrate, in particular a glass substrate for the construction of a liquid crystal display, in which the at least one photoemulsion layer is applied to a side of a flexible polarizing film. An adhesive layer is applied to the other side of the polarizing film, the layer structure with the adhesive layer applied to the polarizing film being laminated onto the substrate.

### SUMMARY

It is an object of the present invention to specify a display element for a display unit of a vehicle that is improved by comparison with the prior art.

The object is achieved according to the invention with the aid of the features specified in claim 1.

Advantageous developments of the invention are the subject matter of the subclaims.

In an inventive display element for a display unit of a vehicle, the display element is formed from a substrate and a polarizing film.

The display element is, in particular, a component of a display unit of a multifunction display unit of the vehicle.

Owing to the fact that the display element is formed from the polarizing film and the substrate, the transmission of electromagnetic radiation produced behind the substrate, that is to say the transmission of visible light, is increased, the reflection caused by the display element itself advantageously being largely excluded. Moreover, the effect of the polarizing film is that a viewer of the display element does not perceive the contour thereof, or at least does so less.

It is provided for this purpose that the polarizing film is applied directly to the substrate in a non-positive, positive and/or bonded fashion. In addition to the avoidance of the reflection, the effect of the direct non-positive, positive and/or bonded fastening of the polarizing film on the substrate is also to reduce the entry of dust and/or moisture into the display element. Furthermore, the non-positive, positive and/or bonded fastening largely prevents the substrate and/or the polarizing film from slipping.

For example, the polarizing film is fastened on the substrate by means of rivets and/or latching connections.

It is particularly preferred to glue the polarizing film onto the substrate by means of an adhesion promoter, the adhesion promoter preferably not being applied completely, but only in regions, to the surface of the substrate and/or the polarizing film. For example, the adhesive is applied only in the edge region of the polarizing film and/or of the substrate, the entry of dust and/or moisture into the display element being counteracted thereby.

Alternatively, the polarizing film can be applied to the substrate in a lamination method. To this end, the polarizing film can be applied to the substrate by hot lamination, on the one hand, and by cold lamination, on the other hand. In the case of hot lamination, an adhesive of the polarizing film that is solid at room temperature fuses with the substrate. To this end, the polarizing film is, for example, arranged with an exact fit on the substrate and, for example, guided over a hot roll in a laminating unit, thus thermally connecting the polarizing film to the substrate. This connection forms a unit from the substrate and the polarizing film, it being possible to undo the connection only destructively.

In a further alternative embodiment, the polarizing film can be arranged on the substrate without further fastening means. To this end, the polarizing film is simply laid onto the substrate.

The polarizing film is, in particular, a circular polarizing film by means of which, inter alia, light entering the display element from outside is prevented from being retroreflected.

The substrate of the display element is preferably imprinted, it being possible, for example, to print onto the substrate scale displays and/or graphic display elements in the form of symbols as information for a driver of the vehicle. Alternatively or in addition, the substrate can also be imprinted with other representations, such as text, for example.

The substrate and the polarizing film preferably have largely identical dimensions, so that the polarizing film covers the entire area of the substrate. Consequently, the reflection that can be caused by an illumination of the display element is prevented or at least reduced for the total area of the substrate.

As an alternative thereto, the polarizing film can have dimensions such that only subregions of the substrate are covered with the polarizing film.

The display unit preferably comprises at least one light source so that the display element can be illuminated. If the display element is not illuminated, the imprinted substrate is not visible by means of the polarizing film, since the polarizing film prevents light reflected by the display element from being visible to a viewer. In this case, the display element appears homogeneously black until the illumination is switched on, and the graphic symbols and the scale displays become visible by means of the illumination, in particular the backlighting. This effect is also denoted as the black panel effect.

### DRAWINGS

The invention is explained below in more detail with the aid of the attached schematics, in which:

FIG. 1 shows a schematic of a view of a display element of a display unit for a vehicle,

FIG. 2 shows a schematic of a section of the display element, and

FIG. 3 shows a schematic of an exploded demonstration of the display element.

### DETAILED DESCRIPTION

Mutually corresponding parts are provided with the same reference symbols in all the figures.

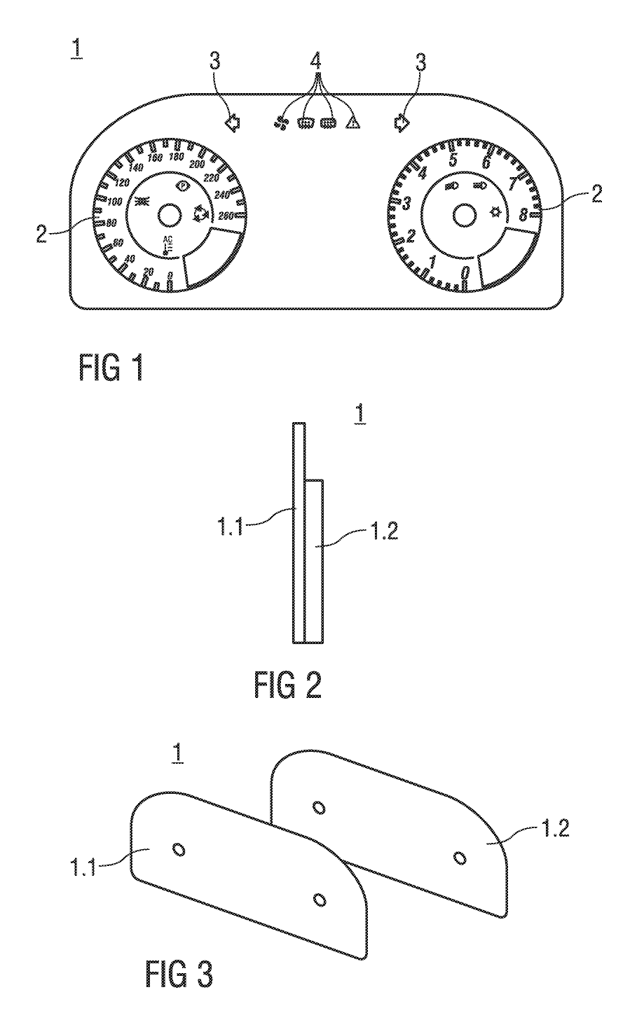

FIG. 1 shows a front view of a display element 1 of a display unit for a vehicle, it being possible for the display unit to be a component of a multifunctional display unit.

Two scale displays 2, direction indicators 3 and graphic symbols 4 for information for a driver of the vehicle are illustrated on the display element 1.

The display element 1 can be illuminated, that is to say backlit, by means of at least one light source (not illustrated in more detail) that is arranged behind the display element 1. The scale displays 2 are illuminated, for example if the ignition or the vehicle lighting is switched on, in which case, by way of example, when an actuating lever is actuated in order to display the driving direction the appropriate direction display 3 is illuminated and the direction indicator 3 therefore flashes.

The graphic symbols 4 of the display element 1 are illuminated upon activation and/or deactivation of the appropriate function.

The display element 1 is formed from a substrate 1.1 (not illustrated in more detail in FIGS. 2 and 3) and a flexible polarizing film 1.2, the substrate 1.1 being imprinted with the scale displays 2, the direction indicators 3 and the graphic symbols 4.

Here, the polarizing film 1.2, which is a circular polarizing film, is applied to the imprinted side, the side of the substrate 1.1 that faces a viewer of the display element 1, that is to say the polarizing film 1.2 is arranged on the substrate 1.1 in a fashion facing the viewer and visible to the viewer.

The effect of the polarizing film 1.2 is that the unilluminated display element 1 is invisible, since the polarizing film 1.2 prevents light reflected by the display element 1 from being visible to the viewer. Moreover, the effect of the polarizing film 1.2 is to raise a transmission level of the light emitted by the light source. If the ignition or the vehicle lighting is not switched on, the display element 1 appears in a homogeneous black, the scale displays 2 and/or the graphic symbols 4 becoming visible only upon activation of the light source which is also denoted as the so-called black panel effect.

The polarizing film 1.2 can be bonded onto the substrate 1.1 by means of an adhesion promoter, the adhesion promoter preferably being applied only to an edge region of the substrate 1.1 and/or of the polarizing film 1.2. The polarizing film 1.2 bears flat against the substrate 1.1. This prevents the ability of dust and/or moisture to enter the display element 1 via the edge region.

The polarizing film 1.2 is preferably laminated onto the substrate 1.1, it being possible to apply the polarizing film 1.2 to the substrate 1.1 by means of hot lamination, on the one hand, and by means of cold lamination, on the other hand.

If the polarizing film 1.2 is laminated onto the substrate 1.1, the polarizing film 1.2 is fastened over the entire area of the substrate 1.1, the result being optimum prevention of the entry of moisture and/or dirt.

Irrespective of whether the polarizing film 1.2 is glued onto the substrate 1.1 by means of an adhesion promoter, and/or laminated, this connection can be undone only destructively.

As an alternative thereto, the polarizing film 1.2 can also be arranged without fastening on the substrate 1.1, the polarizing film 1.2 being laid onto the substrate 1.1.

FIG. 2 shows a sectional illustration of the polarizing film 1.2 fastened on the substrate 1.1. It is shown here that the polarizing film 1.2 bears against the substrate 1.1 over its total area, the dimensions of the substrate 1.1 being selected to be greater than the dimensions of the polarizing film 1.2.

As an alternative thereto, the polarizing film 1.2 can also have dimensions such that the substrate 1.1 is covered only in regions by means of the polarizing film 1.2.

FIG. 3 shows an exploded illustration of the arrangement of the substrate 1.1 and the polarizing film 1.2.

The illuminated display element 1 is invisible under the polarizing film 1.2, since the polarizing film 1.2 prevents light reflected by the display element 1 from being perceptible to a viewer.

### LIST OF REFERENCE SYMBOLS

1 Display element
1.1 Substrate
1.2 Polarizing film
2 Scale display
3 Direction indicator
4 Graphic symbol

1. A display element for a display unit of a vehicle, wherein the display element is formed from a substrate and a polarizing film.

2. The display element as claimed in claim 1, wherein the polarizing film is applied to a front side of the substrate.

3. The display element as claimed in claim 1, wherein the polarizing film is applied to the substrate in a non-positive fashion.

4. The display element as claimed in claim 1, characterized in that wherein the polarizing film is glued onto the substrate.

5. The display element (1) as claimed in claim 1, wherein the polarizing film is laminated onto the substrate.

6. The display element as claimed in claim 1, wherein the polarizing film is a circular polarizing film.

7. The display element as claimed in claim 1, wherein the substrate is printed.

8. The display element as claimed in claim 1, wherein the substrate and the polarizing film have substantially identical dimensions.

9. The display element as claimed in claim 1, wherein the display element is backlit by at least one light source.

10. The display element as claimed in claim 1, wherein the display unit is a component of a multifunction display unit of a vehicle.

11. The display element as claimed in claim 1, wherein the polarizing film is applied to the substrate in a positive fashion.

12. The display element as claimed in claim 1, wherein the polarizing film is applied to the substrate in a bonded fashion.
